(19) United States
(12) Patent Application Publication
(10) Pub. No.: US 2020/0184586 A1
(43) Pub. Date: Jun. 11, 2020

(54) METHOD AND SYSTEM FOR AN ELECTRONIC, STRUCTURED CONTENT MANAGEMENT AND DELIVERY PLATFORM

(71) Applicant: E-AGREE, LLC, Manassas, VA (US)

(72) Inventor: Thomas ERVIN, Manassas, VA (US)

(21) Appl. No.: 16/341,018

(22) PCT Filed: Oct. 11, 2017
(86) PCT No.: PCT/US2017/056186

§ 371 Date: Apr. 10, 2019

Related U.S. Application Data
(60) Provisional application No. 62/407,091, filed on Oct. 12, 2016.

(51) Int. Cl. G06Q 50/18; G06Q 10/10; G06F 16/93; G06F 16/176; G06F 16/18; G06F 40/186; G06F 40/197

(52) U.S. Cl. CPC G06Q 50/188; G06Q 10/103; G06Q 10/107; G06F 40/197; G06F 16/176; G06F 16/1873; G06F 40/186; G06F 16/93

(57) ABSTRACT

The present invention includes a computer operated system and a computer program medium to generate executable two-party executed documents. The system and program provide a common text editor and common language parameters and clauses to provide for a more efficient generation of two-party transaction documents and subsequent reporting on document content. Also disclosed is a secure intra-system document transmission system to enable platform based negotiation and execution.

### CROSS REFERENCE TO RELATED APPLICATIONS

This PCT application claims the benefit priority under from U.S. Provisional Application No. 62/407,091 filed Oct. 12, 2016 which application is incorporated herein by reference in its entirety.

### FIELD OF THE INVENTION

The present invention is directed to the field of document management, specifically the generation of transactional documents, and more specifically to the use of common language tools by the parties in two party transactional agreements.

### BACKGROUND OF THE INVENTION

With the advent of electronic document creation through word processing programs such as WORD, the amount of electronically stored document content has increased to a degree where is often becomes unmanageable. While tools such as “keyword search” allow for searching specific words or phrases within the available content, a “keyword search” fails to provide any analysis in the context of the subject matter. Especially in a corporate setting, the sheer amount of document content requires an analytical tool to create, organize, deliver, receive, and analyze document content.

The core ability of the platform is that it combines (a) customizable parameters (attributes such as “author,” “monetary value of the underlying document,” “effective dates,” etc. with (b) modifiable sentences or clauses in (c) an organized taxonomy, which then (d) assembles the desired document, that (e) can be shared with internal or external parties through the platform on a peer-to-peer basis, and (f) can be managed and reported on based on the underlying structure.

This is in stark contrast to systems that essentially manage already assembled content in files (document management systems), and do not allow management and reporting of the structured content (such as analysis of a specific section of all included content) or sharing between two parties.

The invention addresses this problem of managing content that itself has underlying, varied structures and has many potential applications. For example, companies are required to create, organize, deliver, receive, and analyze large numbers of legal agreements such as Sales Agreements, Consulting Agreements, and Non-Disclosure Agreements. The invention can be applied, for example, to create, organize, deliver, receive, and analyze legal transactions between two parties, such as legally binding agreements. While there are software programs that assist companies in writing and storing agreements (in the form of documents), they do not have in-depth analytical capabilities because the agreements are created and stored based on a file by file basis. The only ways of analyzing such document content is by keyword search or user-assigned tags to pin-point the document of interest. Subsequent manual review of each document is then required to arrive at the matter of interest.

### SUMMARY OF THE INVENTION

The present invention broadly comprises a computer operated system to generate executable two-party executed documents comprising: a first computer store containing a plurality of generated document templates; a second computer store containing a plurality of document parameters; a third computer store containing a plurality of sets of metadata; at least one computer server, each of the at least one computer servers having a microprocessor. Each microprocessor is programmed to perform at least one of the following:
a) retrieve one of the plurality of document templates, the retrieved document templates retrieved by an originator;
b) combine the retrieved document template with a selected one of the sets of metadata, the selected set of metadata selected by the originator;
c) populate the document template with one or more document parameters or one or more categorized clauses from the list of document parameters or clauses in the clause library and/or edit the document template;
d) generate a first version document from the combined and populated document template;
e) transmit the first version document to a one or more different parties via a secured transmission system;
f) enable the second party to execute the first version document or make subsequent edits related to any negotiation or alteration of the document; and,
g) return the executed version document to the first party, wherein the first party executes the first version document D₁ or alters the document to continue the negotiation before execution; and,
h) securely transmit a copy of the executed first version document to the second party; and,
i) quickly run reports on document metadata, clause usage, parameter usage, and other elements of the document.

The computer operated system further comprises a fourth computer store containing said first version document and said executed document and a fifth computer store containing the selected set of metadata.

In another embodiment, the present invention broadly comprises a computer program product comprising at least one non-transitory computer-readable medium, the computer-readable medium comprising a program which, when executed by a device having a processor and at least one display unit, causes the device to:
a) generate a plurality of document templates to be stored in a first computer store;
b) create a plurality of document parameters to be stored in a second computer store;
c) generate at least one set of metadata to be stored in a third computer store;
d) retrieve one of the plurality of document templates, the retrieved document templates retrieved by an originator;
e) combine the retrieved document template with a selected one of the sets of metadata, the selected set of metadata selected by the originator;
f) populate the document template with one or more document parameters or clauses from the list of document parameters or select from the clause library and/or edit the document template;
g) generate a first version document from the combined and populated document template;
h) transmit the first version document to a one or more different parties via a secured transmission system;
i) enable the one or more different parties to execute the first version document; and,
j) return the executed version document to the first party, wherein the first party executes the first version document D₁; and,
k) securely transmit a copy of the executed first version document to the one or more second parties.

The first version document and the executed document are store in a fourth computer store and the selected set of metadata is stored in a fifth computer store.

One object of the invention is to provide common text editing tools to facilitate a more efficient process to generate and transmit transaction documents from an originating party to one or more different parties.

A second object of the invention is to supply a secure communication system to transmit the documents.

A third object of the invention is to provide a common audit trail to access to enable all parties to access previous versions of a particular document.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a screen shot of a list of document templates; utilized by the computer operated system of the invention;

FIG. 2 is a screen shot showing a drop-down menu from which the user can select the desired document template and the chosen multi party entities;

FIG. 3 is a screen shot displaying a document template accessed from the first computer store;

FIG. 4 depicts types of metadata that may be associated with a new document;

FIG. 5 is a screen shot displaying a document template with the metadata inserted into the document;

FIG. 6 is a screen shot depicting a drop-down menu of clauses that can be accessed from a menu and dragged or copied and pasted into the appropriate section of the draft document.

FIG. 6A shows a selected clause dropped into the draft in the desired location;

FIG. 7 shows a screen shot displaying an editing window from which the text of the draft document can be edited in a manner known to those familiar in the art;

FIG. 8 is a screen shot showing a status indicator that can be used to manage the status of the changes made in editing a draft agreement to a second party;

FIG. 9 is a screen shot showing another status indicator of the document being sent to a second party;

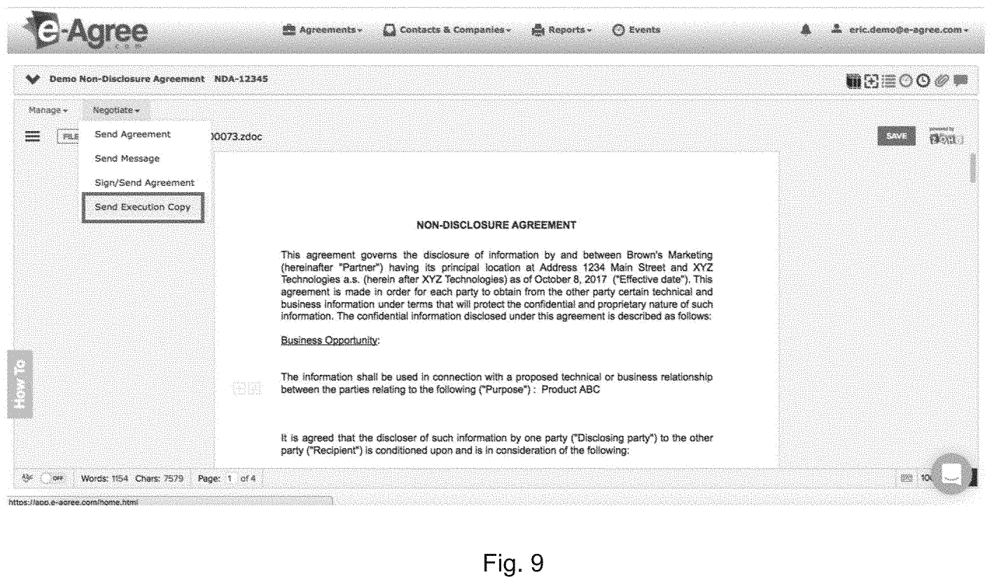

FIG. 10 is a screen shot of a document ready to be executed;

FIG. 11 is a screen shot of an email template with the attached document requesting the receiver sign the document;

FIG. 12 depicting the prompt to enter the signatory name and title on the agreement to be executed;

FIG. 13 is a screen shot of a report listing each of the agreements of a particular user;

FIG. 14 shows a flow diagram demonstrating how the document templates, metadata and the document versions are created and stored;

FIG. 15 is a screen shot depicting the email notice of notification code to be sent to a non-registered user;

FIG. 16 is a screen shot showing an authentication code where the second party is authenticated in order to continue negotiations on the peer-to-peer platform;

FIG. 17 is a screen shot showing the sign/send agreement menu item to be selected by the non-registered user;

FIG. 18 portrays the signature line to be signed by the non-registered user; and,

FIG. 19 is a screen shot of a typical email notifying the registered user that the attached agreement has been signed.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Although any methods, devices or materials similar or equivalent to those described herein can be used in the practice or testing of the invention, the preferred methods, devices, and materials are now described.

The instant invention is a computer operated system and a computer program method that allows for the constructing of a transaction document by an originator party (“originator”) and one or more second parties (“multi-party transaction”). The system and method enables all parties to work on the same version of the document while still having the ability to edit the document, provide comments, and transmit the latest version to the other party via a secured communication link such as an email transmission. In addition, the system provides a calendar, the ability to track various documents that are pending for each party with other entities. Transaction documents are defined as documents that define a relationship between one or more different parties. Examples of transaction documents are, but are not limited to, contracts, assignments, purchase agreements, licenses, real estate sales, etc. Although the following description and figures generally portray transaction(s) between two parties, it should recognized that the computer operated system and computer program product can support a transaction having more than two transacting parties (multiparty transaction”).

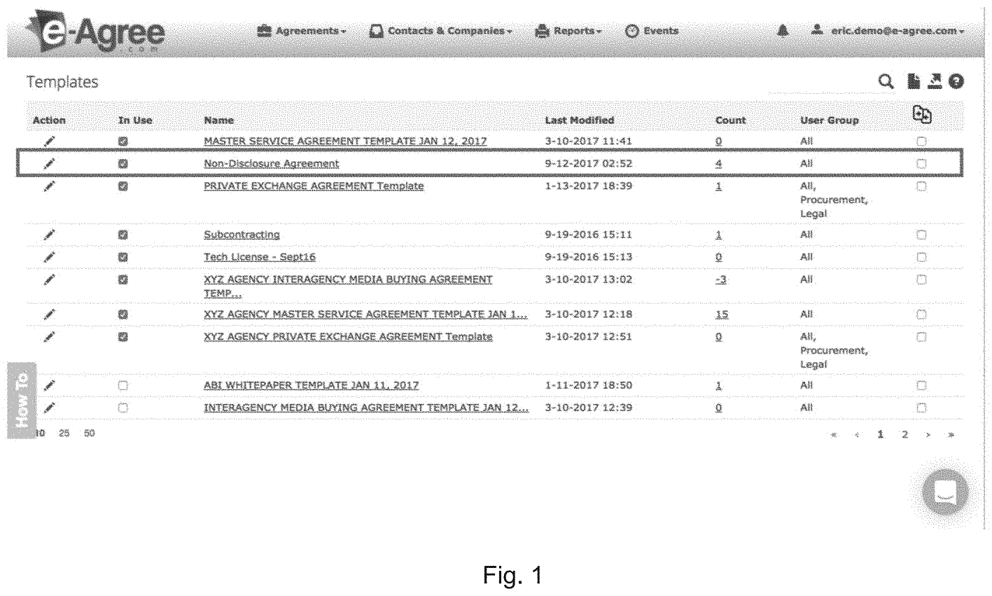

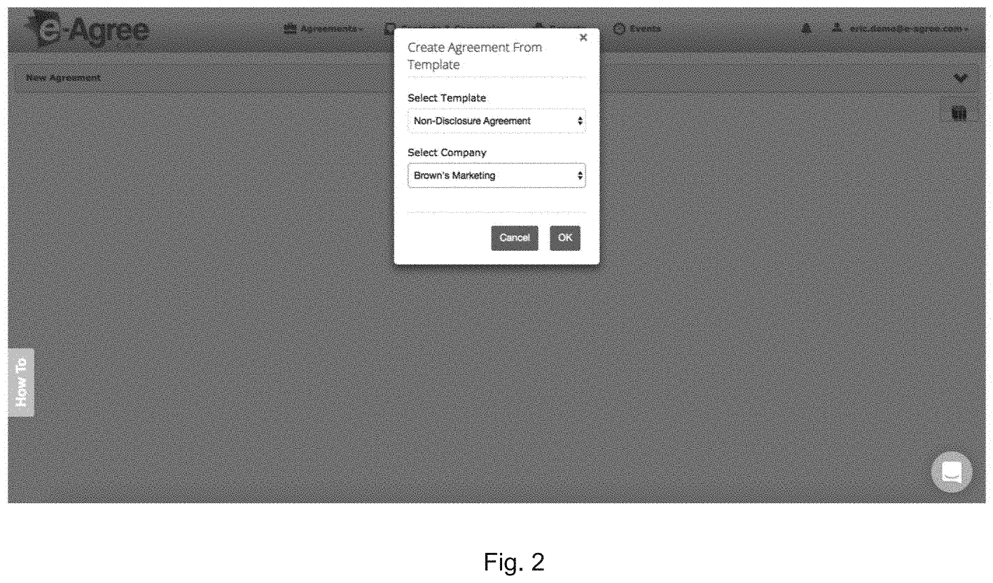

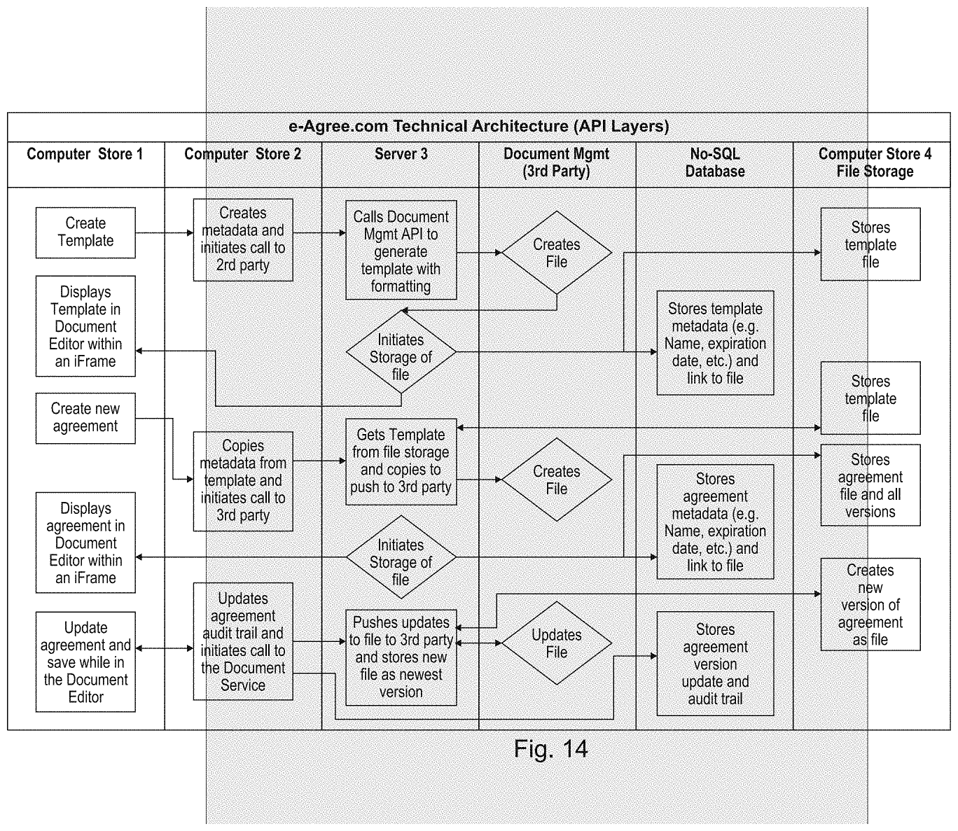

Adverting to drawings, FIG. 1 is a screen shot of a list of document templates. The templates may be created by the system user on a computer and stored within a computer store as seen in the flow chart in FIG. 14. A computer store is defined as a repository of a set of data objects. As can be seen in FIG. 1 from the “last modified” column, the templates can be modified and saved to the template server. A document template can be created by the user as a base document containing boilerplate terminology that can be edited, added to, and/or deleted to fit each individual transaction. FIG. 2 is a screen shot showing a drop-down menu from which the user can select a desired document template and the chosen second party company.

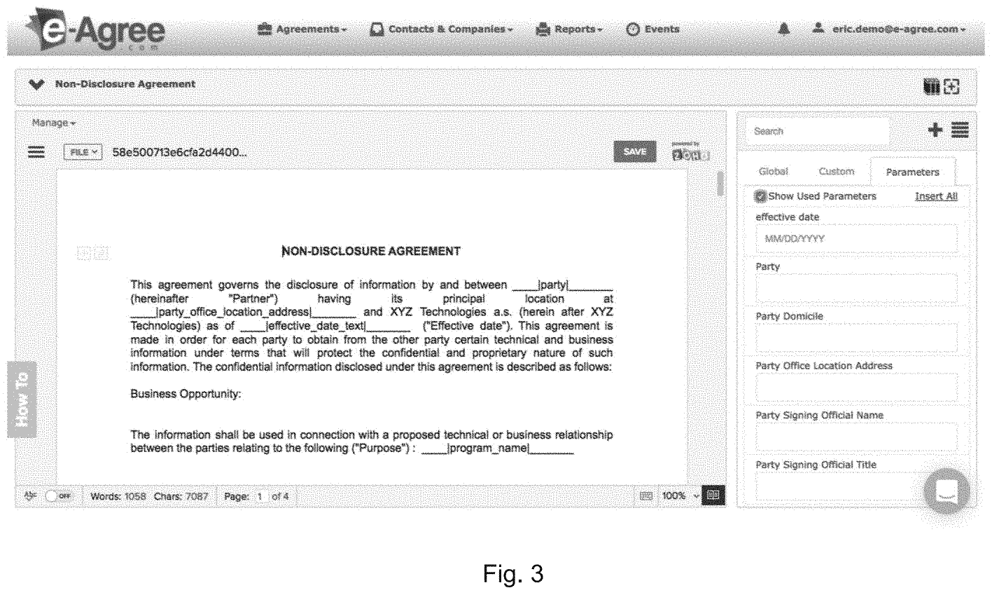

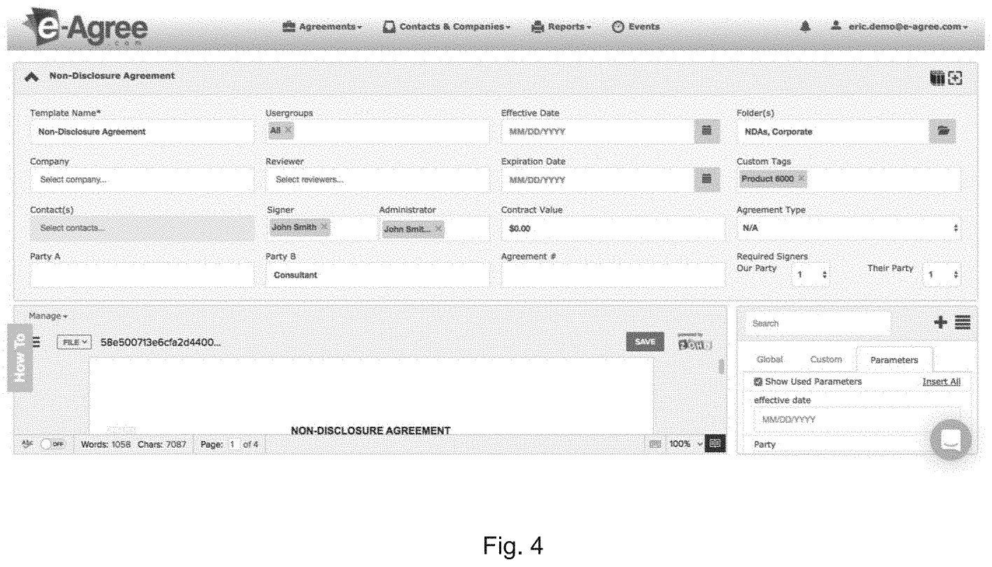

FIG. 3 is a screen shot displaying a document template accessed from the first computer store. In the example shown, the document template is for a non-disclosure agreement. The screen shot in FIG. 4 depicts the metadata for the new NDA that is to be drafted for a new transaction. In this context, metadata is defined as data that is used for purposes such as discovery and identification. It can include elements such as document template type, party identification, contacts, agreement identifier, file storage identification, etc., the system user may access a screen (not shown) displaying a contact listing company identifiers such as name, company contact, email address, phone number, last agreement transacted, etc.

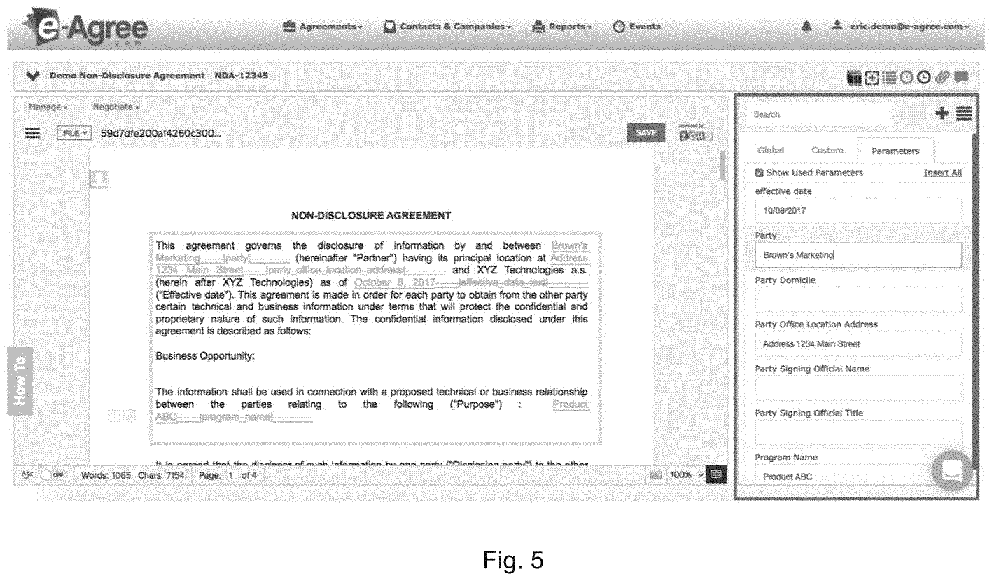

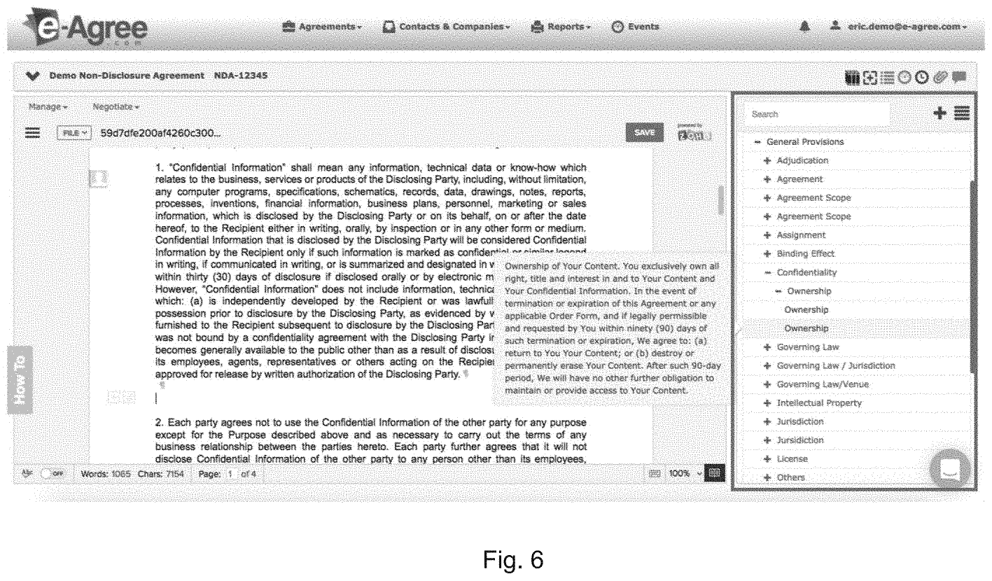

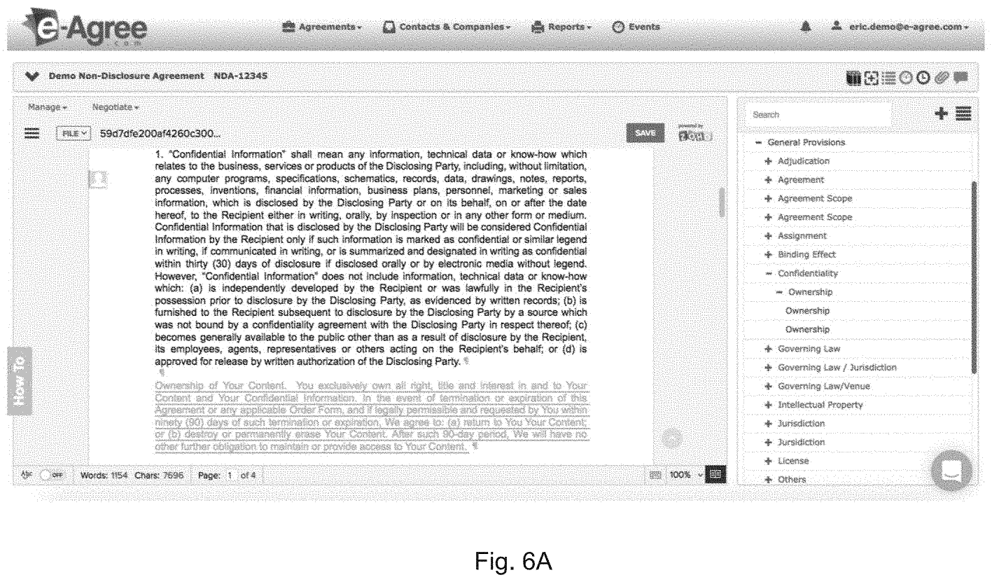

FIG. 5 is a screen shot displaying a document template with the metadata inserted into the document. As shown in the screen shot of FIG. 6, agreement parameters or clauses can be accessed from a menu and dragged or copied and pasted into the appropriate section of the draft document. As can be seen, a parameter directed to ownership of content obtained from the ownership menu and dropped into the draft NDA between sections 1 and 2. FIG. 6A shows the ownership clause(s) dropped into the draft in the desired location. It should be emphasized that not only can parameters be added to the document, but the original boilerplate language and the text of the parameters themselves can also be edited as needed.

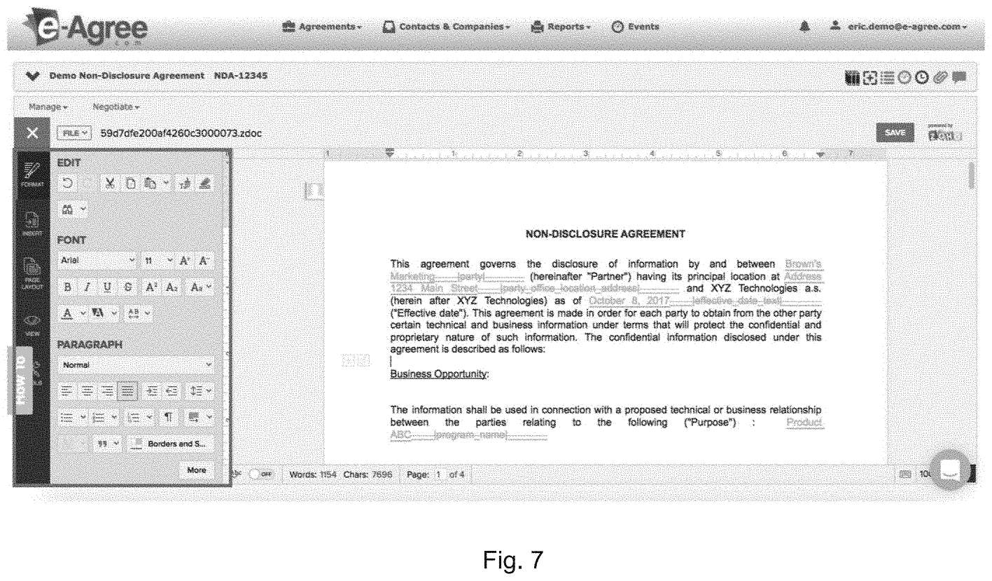

FIG. 7 shows a screen shot displaying an editing window from which the text of the draft document can be edited in a manner known to those familiar in the art. In the example shown, a typical cross out/underlining of text indicates text deletion/insertion in a well known manner.

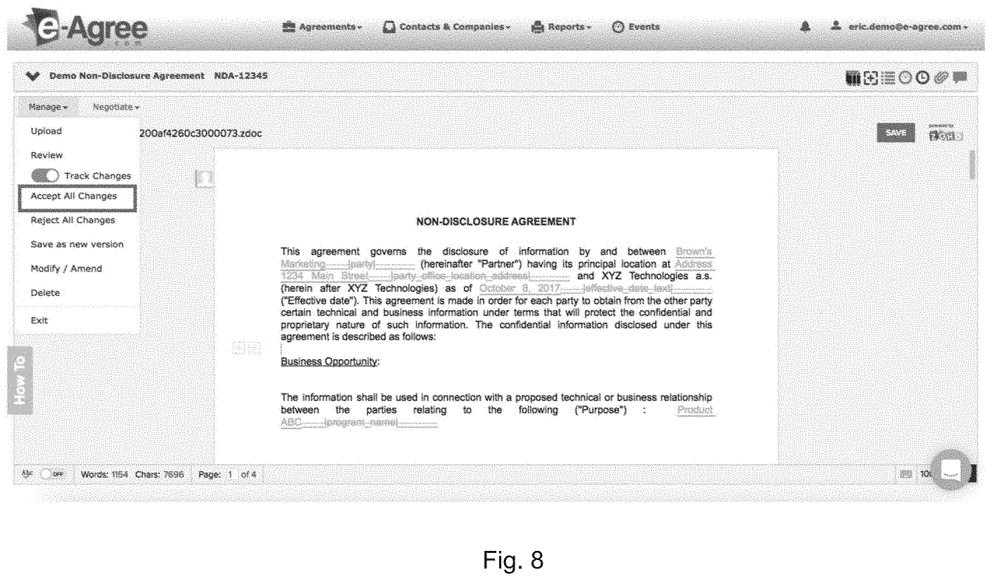

FIG. 8 depicts a “track changes” window dropped down under the “Manage” drop down box displaying the menu of choices managing and reviewing the draft document including options for managing the changes. It will be recognized that other options or option labels may be utilized in the Manage menu. In a preferred embodiment, the drafter of a particular version cannot accept changes on that version.

Seen next to the Manage drop-down box is a “Negotiate” drop-down box. As seen in FIG. 8, this box includes options for transmitting the draft agreement to the second party. One option may be labeled “Negotiate/Send Agreement” meaning that a hyper link is transmitted to the second party via email which grants access to the draft document. Other attachments may be attached as well as inserting comments in the body of the email, such as the reasoning behind the latest changes. It will be recognized that the draft agreement may be sent with the changes still displayed as cross outs and underscores. The second party may then go through the same method of inserting and deleting text using the change menu and returning it to the originator using the same secured email system. During the negotiation and editing processes, the drafting statuses, e.g., first version, second version, etc., and a time/date stamp for each version can be displayed. Preferably, for the second or receiving party to make additional changes, the received draft document should be saved as a new version. This provides the advantage of easily denoting who made the changes to a particular draft version.

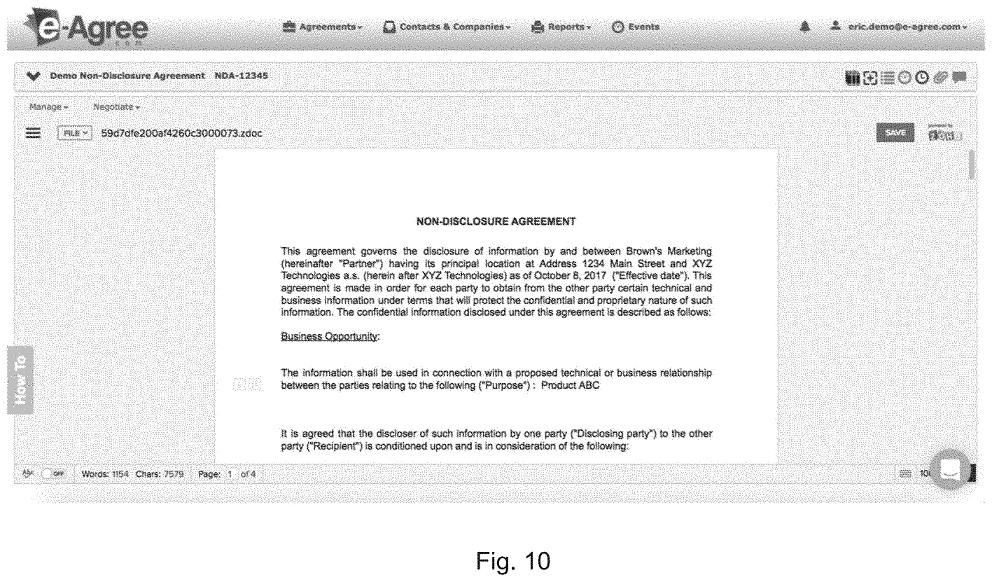

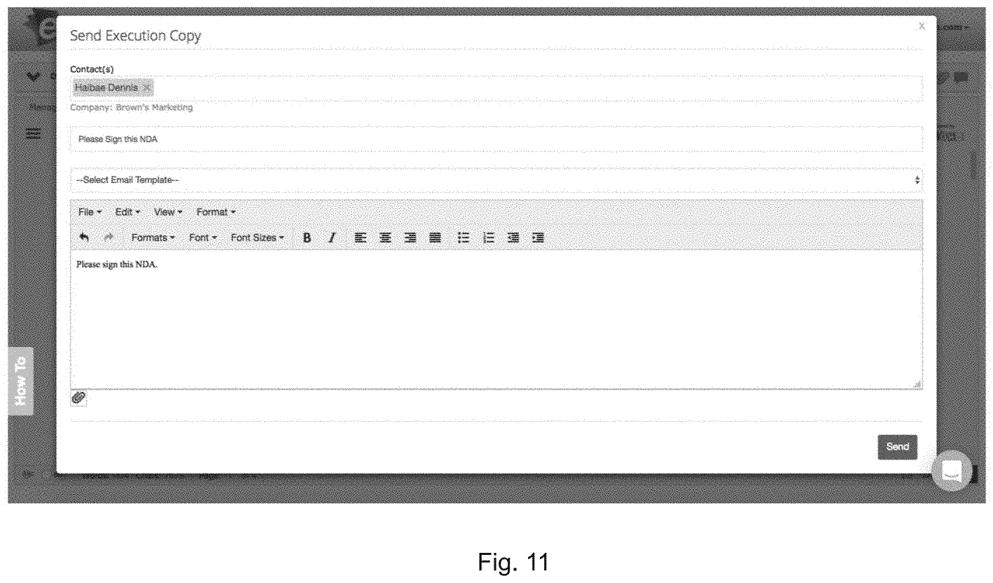

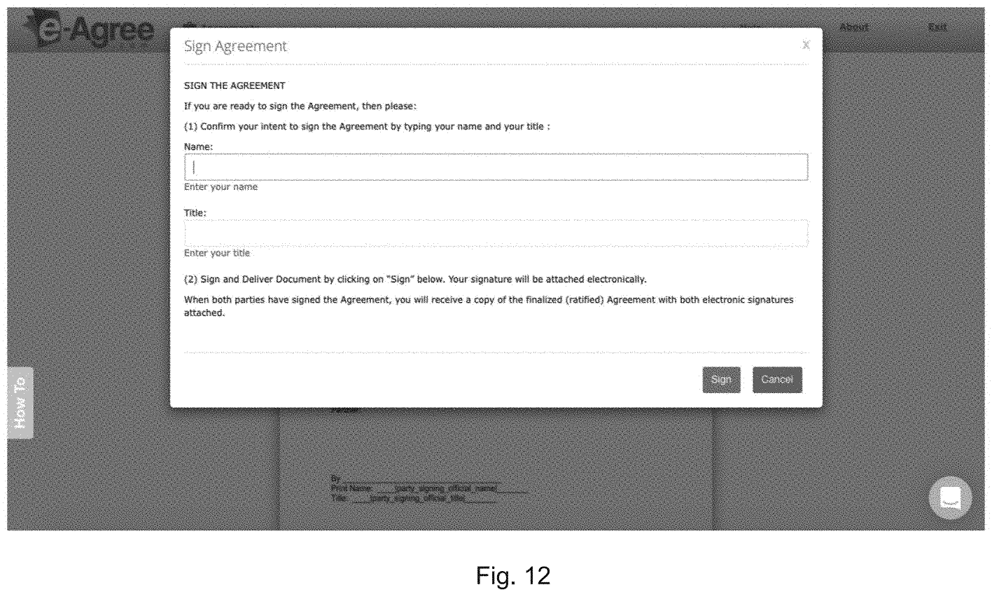

When the agreement is ready to be signed, an execution copy may be sent from either the originator or the second party. This can be done again using the Negotiate drop-down box and selecting an option labeled “Negotiate/Send Execution Copy” or some other suitable description. Preferably, this version is prepared with controls so that it may only be signed and not edited further. FIG. 10 is a screen shot of a document ready to be executed. FIG. 11 is a screen shot of an email template with the attached document requesting the receiver sign the document. In one embodiment, the party to execute (sign) the agreement will select Sign/Send from the Negotiate drop-down menu. This will prompt the signer to click on the part of the document where a digital signature is to be placed. This will activate the prompt to enter name and organization title as seen in FIG. 12. Once one party has signed the agreement, the other party is automatically notified that the agreement is ready for signature. Once both parties have signed the agreement, the final copy will automatically be uploaded and associated with the final version and available for download form the computer-operated system to each party.

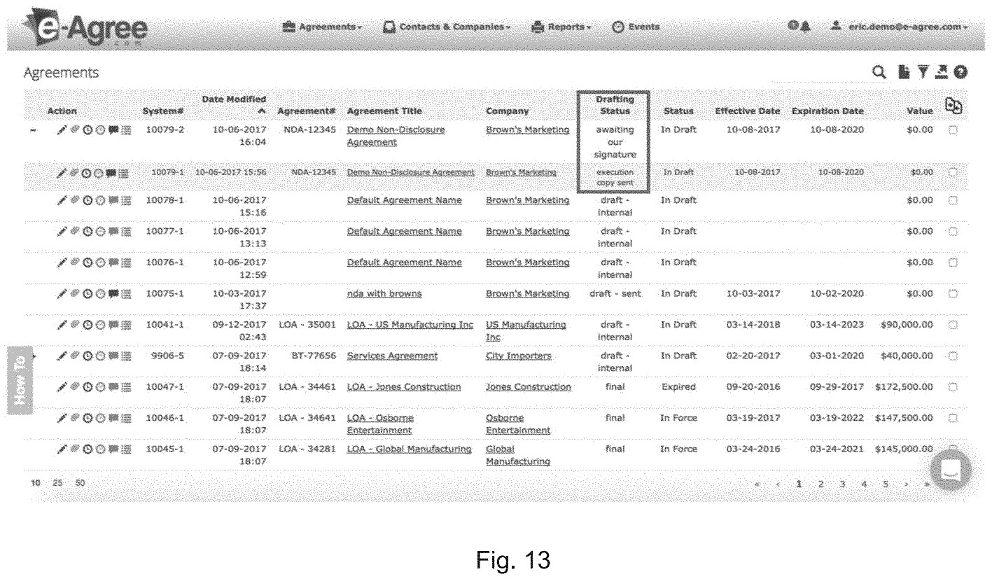

In one embodiment, various reports may be generated from the metadata stored as each of the documents are generated. FIG. 13 is a screen shot of a report listing each of the agreements of a particular user along with the second party, the status of the agreement, agreement ID number, effective date, expiration date, etc. Other reports may be generated such as, but not limited to, a list of companies, types of document templates, etc. In an alternate embodiment, the computer operated system will provide filters and a preview mode to enable selection and adjustment of filters and search terms to extract the exact data desired in the report. Reports may be generated based on filters such as, but not limited to, enforcement clauses, definitions, and state law of enforcement.

FIG. 14 shows a flow diagram demonstrating how the document templates, metadata and the document versions are created and stored. Row 1 depicts the generation of a document template and associated metadata. The computer operated transaction system of the present invention may be a web-based system using a several servers as computer stores for document files, templates and metadata files, while using other servers to create and edit document files. Document templates are created and stored in computer store which may be located on one or more servers and is accessed by one or more users using a computer or microprocessor. Metadata is created on computer store 2 which also initiates the notification to a third party. In discussing FIG. 14, “third party” means either the originator or the second party as a party having access to the computer operated system and thus access to the stored templates and metadata to originate a first version document D₁ or a subsequent versions D₂, . . . Dₙ. Server 3 may use programs such as Java to perform activities such as generating the template with formatting while a document management program creates the transaction document file. The Java server initiates storage of the file on a separate computer store 4 and also activates the display of the document file on computer store 1. A database server stores the metadata for the developing document while computer store 4 stores the document template. The document parameters associated with a particular template may be stored with the completed template or separately.

Row 2 depicts one embodiment of the development of a document by an originator. The selected second party identifying metadata is selected and inserted into the selected document template at server 3. At the same time, the party identified by the metadata is notified that a new version is being prepared by the other party. Server 3 retrieves the stored template and inserts the metadata and creates the file.

In Row 3 the agreement is displayed on a document editor and edited to include populating it with the prepared parameters. The new version of the document is stored on computer store 4. As later versions of the document are prepared they are each stored to create an audit trail regarding each of versions D₁ through Dₙ to store the history of the development of the agreement by both parties. Row 4 shows the creation of the last step utilizing the computer stores and servers discussed above. Also, as discussed above, the final signed version is also stored with the previous versions. It will be recognized that the actions of row 3 may be repeated an unlimited number of times until a final agreement is reached or the process is stopped by one or both parties.

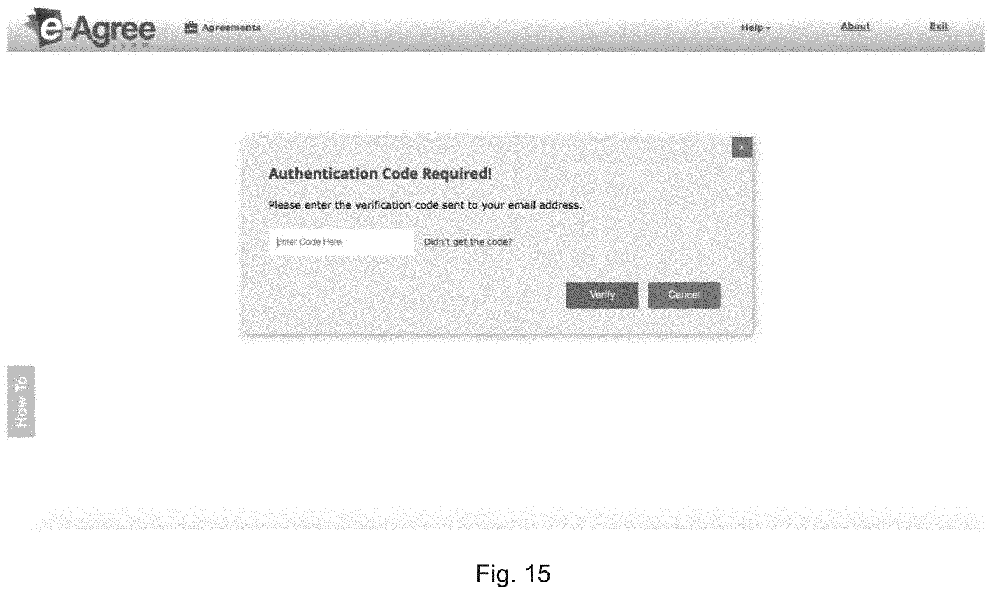

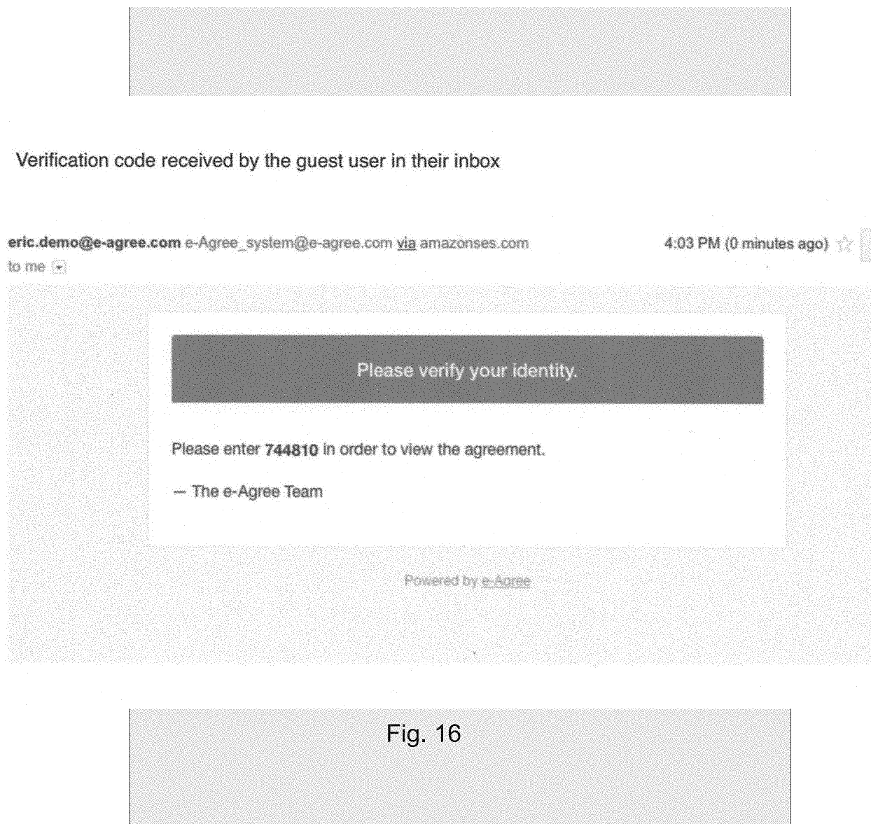

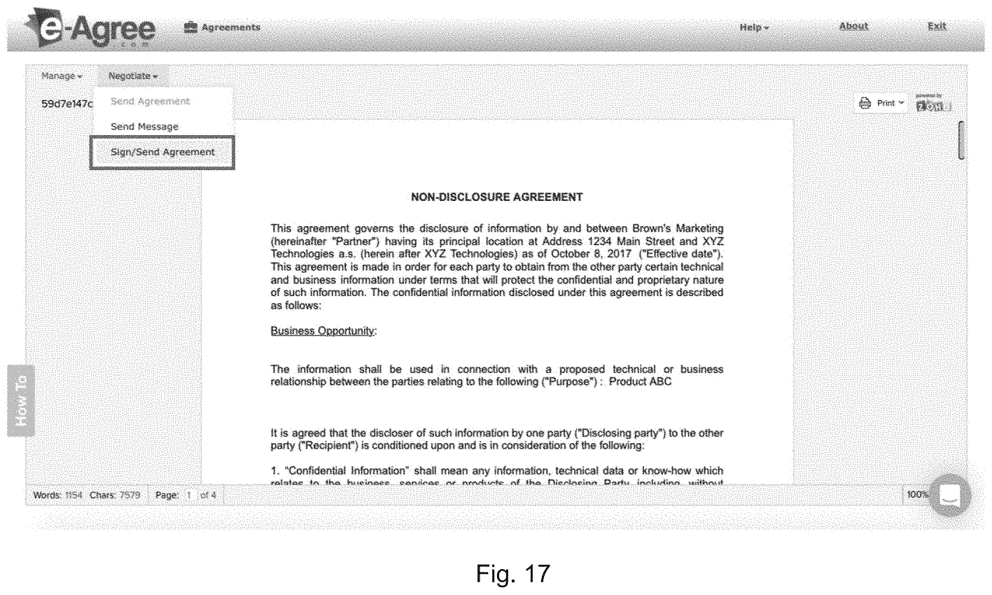

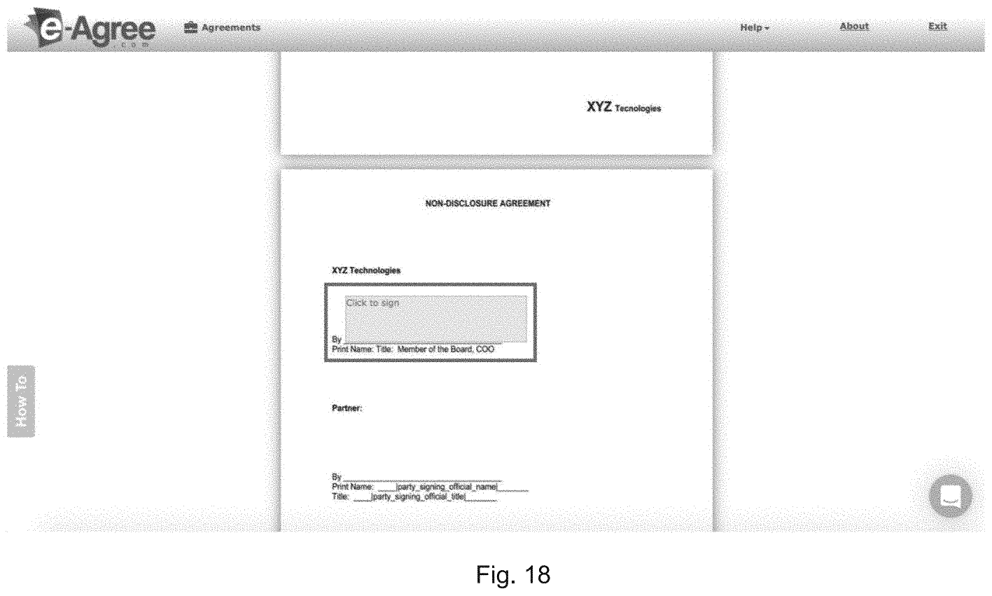

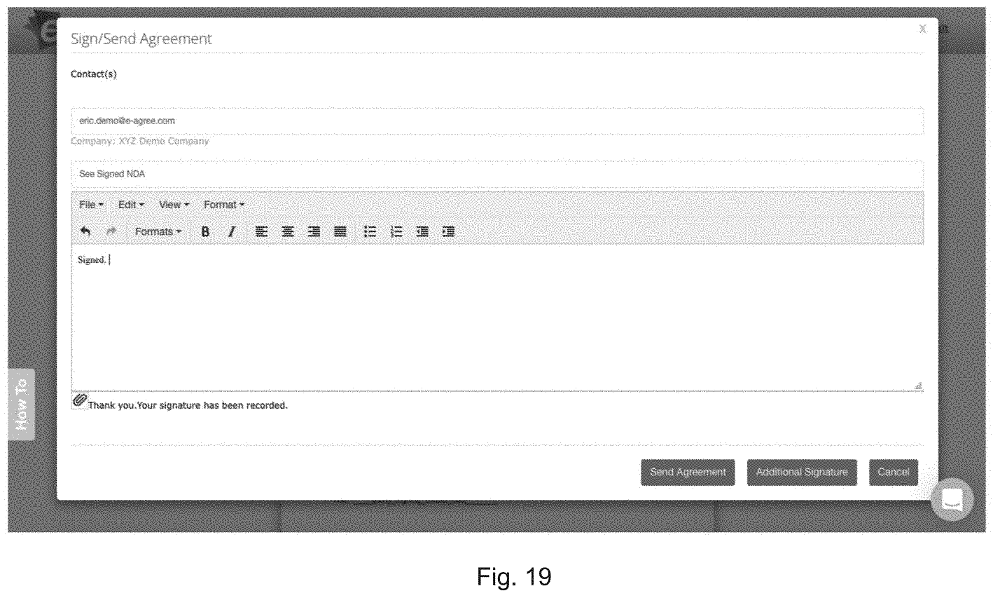

In one embodiment, users of the computer operated system of the present invention are both registered meaning both have access to all the documents they have created with the other party or any other party. In another embodiment, the second party is a non-registered user. A non-registered user may access, edit, and transmit the documents generated during a particular transaction but preferably does not originate the first version of the document. In order to access the system, a non-registered user receives an email informing him of the requirement to access the system using an authentication code which is generated and transmitted immediately afterwards. FIG. 15 is a screen shot depicting the email notice of the notification code. FIG. 16 is a screen shot showing the authentication code itself. FIG. 17 is a screen shot showing the sign/send agreement menu item to be selected by the non-registered user while FIG. 18 portrays the signature line. FIG. 19 is a screen shot of a typical email notifying the registered user that the attached agreement has been signed.

The computer-operated system of the present invention has several advantages over typical transaction methods. Communication between the transacting parties is made more efficient over the prior art in that the emails containing unique links to different versions of the document are automatically pushed (transmitted) from one party to the other allowing access to the invention. In addition, when both parties are registered users, they have access to the metadata and parameters so that common language is used avoiding time lost while the shades of meaning of similar words are parsed and decided upon. Each party has access to a common computer-generated audit trail so that there can be no question as to who proposed a particular clause or term in each version leading to a decrease in possible future disputes.

Thus, it is seen that the objects of the invention are efficiently obtained, although changes and modifications to the invention should be readily apparent to those having ordinary skill in the art, which changes would not depart from the spirit and scope of the invention as claimed.

1. A computer operated system to generate executable multiple party executed documents comprising:
a first computer store containing a plurality of generated document templates;
a second computer store containing a plurality of document parameters;
a third computer store containing a plurality of sets of metadata;
at least one computer server, each of the at least one computer servers having a microprocessor, wherein each microprocessor is programmed to perform at least one of the following:
i) retrieve one of the plurality of document templates, the retrieved document templates retrieved by an originator;
j) combine the retrieved document template with a selected at least one of the sets of metadata, the selected set of metadata selected by the originator;
k) populate the document template with one or more document parameters and/or one or more categorized clauses from the list of document parameters and/or list of categorized clauses and/or edit the document template;
l) generate a first version document from the combined and populated document template;
m) transmit the first version document to at least one second party via a secured transmission system;
n) enable the at least one second party to execute the first version document; and,
o) return the executed version document to the first party, wherein the first party executes the first version document D₁; and,
p) securely transmit a copy of the executed first version document to the at least one second party;
a fourth computer store containing said first version document and said executed document; and,
a fifth computer store containing the selected set of metadata.

2. The computer operated system of claim 1 wherein each microprocessor is programmed to further perform at least one of the following:
e1) enable the at least one second party to populate the first version document D₁ with one of more document parameters from the list of document parameters and/or one or more clauses from the list of categorized clauses and/or edit first version document D₁ to form a second version document D₂;
e2) transmit the second version document D₂ to the first party; and,
e3) repeat steps c-e3).

3. The computer operated system of claim 1 wherein the first party and the at least one second party may produce documents D₁, . . . Dₙ and wherein each of document versions D₁, . . . Dₙ is stored.

4. The computer operated system of claim 1 wherein each of document versions D₁, . . . Dₙ is accessible to each of the originator and the at least one second party after storage of the executed document.

5. The computer operated system of claim 1 wherein each of the originator and at least one second party are registered users of the computer operated system.

6. The computer operated system of claim 1 wherein the at least one of the at least one second party is a non-registered user of the computer operated system.

7. The computer operated system of claim 1 wherein the document template is editable.

8. The computer operated system of claim 1 wherein the metadata is editable.

9. The computer operated system of claim 1 wherein the document parameters and categorized clauses are editable.

10. The computer operated system of claim 1 wherein any one of plurality of computer stores may be combined with one or more of any one other of the plurality of computer stores to form one or more combined computer stores;
wherein each of the combined compute stores retains the same storage function of the each of the any one computer stores.

11. A computer program product comprising at least one non-transitory computer-readable medium, the computer-readable medium comprising a program which, when executed by a device having a processor and at least one display unit, causes the device to:
l) generate a plurality of document templates to be stored in a first computer store;
m) create a plurality of document parameters to be stored in a second computer store;
n) generate at least one set of metadata to be stored in a third computer store;
o) retrieve one of the plurality of document templates, the retrieved document templates retrieved by an originator;
p) combine the retrieved document template with a selected one of the sets of metadata, the selected set of metadata selected by the originator;
q) populate the document template with one or more document parameters from the list of document parameters and/or one or more categorized clauses from the list of categorized clauses and/or edit the document template;
r) generate a first version document from the combined and populated document template;
s) transmit the first version document to at least one second party via a secured transmission system;
t) enable the at least one second party to execute the first version document; and,
u) return the executed version document to the first party, wherein the first party executes the first version document D₁; and,
v) securely transmit a copy of the executed first version document to the at least one second party;
wherein the first version document and the executed document are store in a fourth computer store; and,
wherein the selected set of metadata is stored in a fifth computer store.

12. The computer program product of claim 11 wherein the device is further programmed to perform at least one of the following:
i1) enable the at least one second party to populate the first version document D₁ with one of more document parameters from the list of document parameters and/or one or more categorized clauses from the list of categorized clauses and/or edit first version document D₁ to form a second version document D₂;
i2) transmit the second version document D₂ to the first party; and,
i3) repeat steps f-i3).

13. The computer program product of claim 11 wherein the first party and the at least one second party may produce documents D₁, . . . Dₙ and wherein each of document versions D₁, . . . Dₙ is stored.

14. The computer program product of each of claim 11 wherein each of document versions D₁, . . . Dₙ is accessible to each of the originator and the at least one second party after storage of the executed document.

15. The computer program product of each of claim 11 wherein each of document versions D₁, . . . Dₙ is accessible to each of the originator and the at least one second party after storage of the executed document.

16. The computer program product of claim 11 wherein at least one of the at least one second party is a non-registered user of the computer operated system.

17. The computer program product of claim 11 wherein the document template is editable.

18. The computer program product of claim 11 wherein the metadata is editable.

19. The computer program product of claim 11 wherein the document parameters and the categorized clauses are editable.

20. The computer program product of claim 1 wherein any one of plurality of computer stores may be combined with one or more of any one other of the plurality of computer stores to form one or more combined computer stores;
wherein each of the combined compute stores retains the same storage function of the each of the any one computer stores.
